(19) United States
(12) Patent Application Publication
(10) Pub. No.: US 2004/0179093 A1
(43) Pub. Date: Sep. 16, 2004

(54) Remote camera system

(76) Inventor: Sabit Inan, Chicago, IL (US)

Correspondence Address: DENNIS A. GROSS, D|B|A THE HILL FIRM, 666 DUNDEE RD, SUITE 1201, NORTHBROOK, IL, 60062, US

(21) Appl. No.: 10/379,292

(22) Filed: Mar. 4, 2003

(51) Int. Cl. H04N 7/00

(52) U.S. Cl. 348/36

(57) ABSTRACT

A remote surveillance video camera mounted to a pan and tilt drive is provided with a co-mounted light fixture which moves with the camera to illuminate the field of view of the camera. The light fixture is actuatable independent of the camera. The camera may be mounted to the pole through a lifting and lowering device equipment with a separable coax connector automatically connected and disconnected by operation of the lifting and lowering device.

### BACKGROUND OF THE INVENTION

1. Field of the Invention

This invention relates to remote surveillance cameras and more particularly to a camera and light combination provided with a pan and tilt platform which may be connected through a lifting and lowering assembly to a support.

2. Description of the Related Art

Remote mounted video cameras used for security and surveillance observation are known, including those that are supported on poles through a fixture lowering assembly having automatically engagable and disengagable electric contacts. Such devices, as, for example, shown in U.S. Pat. No. 6,261,122, the teachings of which are herein incorporated, may include upper and lower housings which are selectively joinable and separable utilizing a movement actuated latching assembly. The housings each carry electrical contact components which are engagable and disengagable during latching and unlatching movements.

Affixed to a lower one of the housings is a device which may support a surveillance camera. Alternatively the device could support a light fixture. Such lowering systems may, for example, be pole mounted with one of the housings affixed to the pole, for example at the end of an arm, and the other housing being attached to a cable which in turn may be routed through the first housing, the pole arm and the pole to a location in the pole where it may be accessible from the ground level. This cable may be used to activate and deactivate the latching system to allow the cable attached lower housing to be transited between a lowered position and a raised upper housing engaging position.

While such devices have been used with surveillance camera systems which include positioning devices for controlled movement of the camera, either automatically or on command, the resultant security system depends upon ambient lighting or the use of night vision-type optic assemblies for image capture.

Additionally, such assemblies normally include multi-prong electric contact assemblies which rely upon pin and socket electric contacts generally with the sockets and pins being permanently attached to the associated wiring and being affixed to mating opposed mounting bodies, one of which is carried by the upper housing and the other which is carried by the lower housing. While such electrical connections can provide for most types of power and signal transmission, they are not optimized for complex signal transmissions such as video which may be susceptible to RF interference. Such signals are more advantageously carried through coaxial cable and it would therefore be an improvement to provide for the use of coax cable.

It would additionally be an improvement to provide a surveillance camera system which is not dependent upon ambient light by reason of being provided with its own light source which can move and be aimed with the camera.

### SUMMARY OF THE INVENTION

This invention provides a combined surveillance camera and light fixture commonly mounted to a tilt and pan base adapted to be fixedly mounted to a supportand remotely controlled. Surveillance cameras, generally video cameras, are becoming increasingly relied upon both for providing a record of events and for real time remote observation. This invention, as is known in the art, utilizes a video camera affixed to a rotatable and elevatable support commonly known as a pan and tilt drive. In order to enhance the image capture in low ambient lighting situations, a light fixture, either a spotlight or a floodlight, is also attached to and carried by the pan and tilt drive and is commonly aligned with the optics of the camera. Preferably the light fixture used is of that type known as a hot restrike HID lamp. Hot restrike lamps, unlike normal HID lamps, have no significant warm-up time before full illumination as they are maintained in a state of readiness by a constant low level electric supply.

In an embodiment of this invention, a pan and tilt drive provides a mountable support for brackets carrying, respectively, a video camera and a lamp which are parallel mounted such that the axis of the camera optics and of the beam of the lamp will be commonly aimed by movement of the pan and tilt assembly.

In an embodiment of the invention a paralleled lamp and surveillance camera are mounted to a pan and tilt drive which in turn is pole mounted and which may be positioned remotely from a controller-monitor.

In a further embodiment of the invention, a pan and tilt assembly may be mounted to a pole through the intermediary of a lifting and lowering assembly with the pan and tilt assembly attached to one housing portion of the lifting and lowering assembly and a second housing portion attached to the pole. Electrical contacts, connectable and disconnectable by axial movement of the housing halves towards and away from one another are provided in the lifting and lowering assembly and electrical connections respectively to the pan and tilt assembly, the surveillance camera and the lamp are provided through the electrical contacts in the lifting and lowering assembly. To provide for signal security, the video signals from the surveillance camera pass through coaxial cable and the lifting and lowering assembly includes a coax cable connection with one part of the connector carried by each of the housing portions and at least one of the connectors may be provided with a standard push-and-turn bayonet locking coax connector attached to the coax cable from the camera.

It is therefore an object of this invention to provide an improved security camera system employing a directed beam lamp aligned with the optics of a remote mounted security camera.

It is another object of this invention to provide an improved security camera system employing a remote mounted controllable position camera and lamp, with the camera and lamp supported by a pan and tilt assembly in such a fashion that the lamp beam and camera optics are parallel aligned with the lamp being independently actuatable with respect to the camera.

It is another object of the invention to provide an improved surveillance camera system employing the video camera joined with a selectively actuatable instant on HID lamp with the lamp and camera commonly mounted to a pan and tilt assembly, all being remote controlled and being positionable on or hanging from a pole.

It is another object of this invention to provide an improved electrical connection system for remote surveillance cameras wherein the camera signal is routed through a coax cable which corrects to another coax cable at a lifting and lowering assembly mount for the camera and with the coax cable connection including a disconnectable connection interior of the lifting and lowering assembly.

These and other objects of this invention will become apparent to those of ordinary skill in the art from the following description of the preferred embodiment.

### BRIEF DESCRIPTION OF THE DRAWINGS

FIG. 1 is a perspective view of a surveillance camera and light fixture carried by a pan and tilt drive attached to a pole through a raising and lowering device.

FIG. 2 is a partially sectioned view of a coax connector assembly in a disconnected raising and lowering device.

FIG. 3 is a plan view of a coax connector, in a connected raising and lowering device.

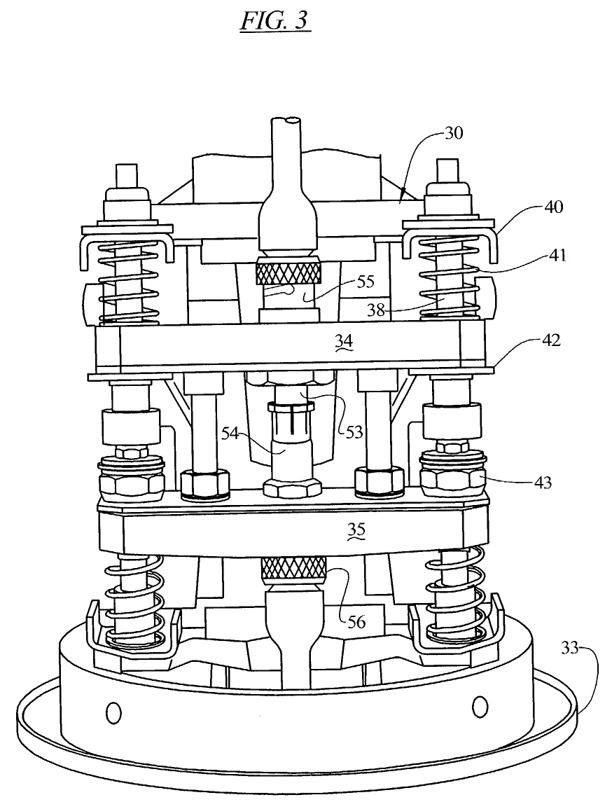

FIG. 4 is a perspective view of a pole mounted surveillance camera and light with a pan and tilt drive affixed to the pole.

### DESCRIPTION OF THE PREFERRED EMBODIMENT

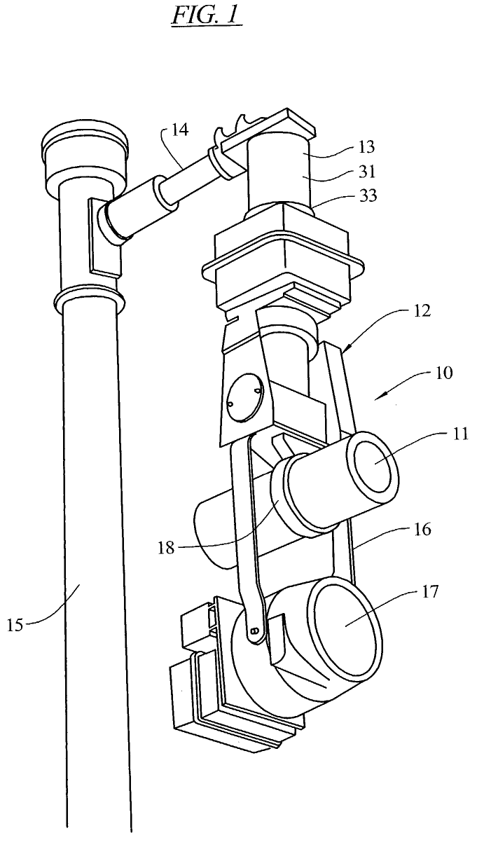

As shown in FIG. 1, a surveillance system 10 is provided including a remote controlled video camera 11 carried by a pan and tilt drive by fixed or adjustable bracketing 18. The pan and tilt drive 12 is in turn carried through a fixture lowering assembly 13 of the type described in U.S. Pat. No. 6,261,122, the teachings of which are herein incorporated by reference. The fixture lowering assembly may be carried by an arm 14 attached to a pole 15. Fixed or adjustable Bracketing 16 carried by the pan and tilt drive 12 supports light fixture 17 whose beam is aimed substantially parallel to the optical axis of camera 11. The bracketing 18, 16 maintains the alignment of the camera view and light beam.

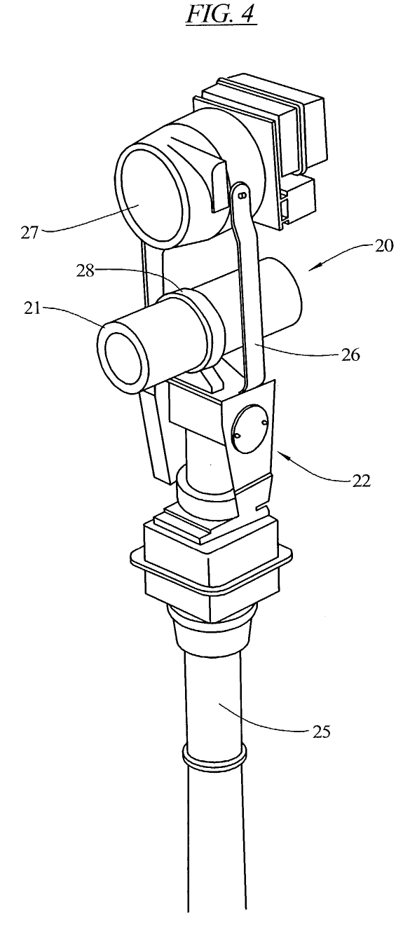

As shown in FIG. 4 substantially the same surveillance system 20 can be directly mounted to a pole 25 via a pan and tilt drive 22 where a surveillance video camera 21 is attached to the pan and tilt drive 22 as by bracketing 28, and bracketing 26 carries light fixture 27 mounted such that the beam from light fixture 27 is substantially parallel to the optical axis of the video camera 21. It would be appreciated that the principal difference between FIG. 4 and FIG. 1 is the use of the fixture lowering assembly 13. Although FIG. 4 illustrates the security system 20 mounted atop the pole 25, it would be understood that this is shown primarily to illustrate a mounting freedom of obstacle to providing a 360 degree uninterrupted surveillance. Where such all around surveillance is not necessary, the pole 25 could be replaced with a different stationary mount arrangement, such as a bracket affixed to a side of a building. Alternatively the surveillance assembly can be mounted to a pole arm or the like.

As is well known in the art, cameras for remote surveillance include both fixed and variable (zoom) optic systems and are often provided in weatherproof housings. Light fixtures of the type illustrated at 17 and 27 are also well known to the art and suitable ones can be obtained from, for example, Northstar Lighting of Broadview, Ill. Suitable lights include those having directed beams having a beam angle compatible with the field of view angle of the optical system of the surveillance camera. The light fixture may be quipped with reflectors and/or lenses to provide specific beam characteristics and can provide a symmetrical or symmetric light distribution. A preferred type of lighting fixture is a hot restrike HID fixture. Typically a hot restrike fixture, once powered, can be quickly switched between beam on and beam off conditions. A suitable pan and tilt is Model No. 017000 V390APT from Vicon Industries. A suitable camera housing is Model No. 440300 V8650H-18 from Vicon Industries. A suitable color camera is Model No. 762604 VC3050-DSP available from Vicon Industries. A suitable motorized zoom is Model No. 586200 VG-60AC-HS-1 from Vicon Industries. A suitable control keypad is Model No. 664900 V1411X-DVC from Vicon Industries. A suitable hot restrike flood light is Model No. CSI1000S120 HHRU from North Star Lighting Inc. A suitable camera lowering system is Model No. CDP-XYZZ-XX from North Star Lighting Inc. (U.S. Pat. No. 6,261,122).

By providing a co-mounted light fixture having a beam angle compatible with the view angle of the optics and having a beam strength chosen to provide a sufficient level of illumination for the surveillance camera at the camera's operating range distance, a remote security system can be created which is independent of area lighting systems for nighttime surveillance. By providing an on/off actuatable light fixture, the surveillance system allows for a lower energy expenditure during sufficient ambient lighting conditions and further provides versatility of operation including scare-away operation. Where adequate, low-level ambient light exists or where the surveillance camera may be provided with enhanced light capture capabilities, the light fixture would be left in a standby state during normal monitored surveillance operations. Upon receiving an indication of a surveillance interest occurrence, the light can be operated to illuminate the area of the suspected occurrence. In many instances, particularly intended surreptitious or accidental perimeter incursions the occurrence will be stopped merely by activating the light directed to illuminate the area of incursion.

The combination of a parallel mounted duo of light and camera with an on/off operable light actuatable separate from the camera can be provided an effective security system. In order to allow wide-angle and targeted surveillance the parallel mount duo is preferably coupled to a commercially available pan and tilt remote drive.

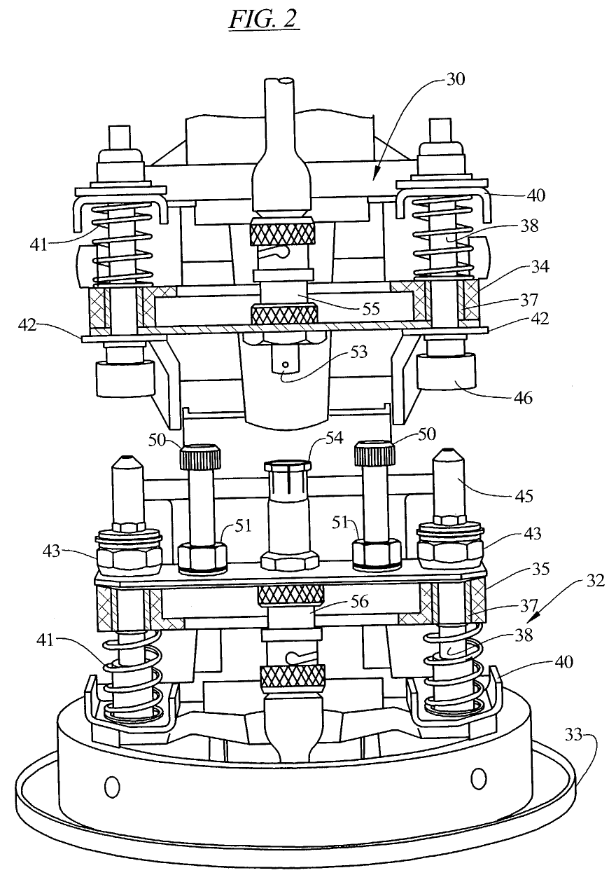

To accommodate periodic maintenance, repair and cleaning, the surveillance system 10 is preferably pole mounted through a fixture lowering assembly 13 of the type generally described in U.S. Pat. No. 6,261,122. As shown in FIGS. 1 and 2, such assemblies include an upper connector assembly 30 received in an upper housing 31 and a lower connector assembly 32 received in a lower housing 33 with the housings matable in an environmentally protected mating. The upper connector assembly is substantially fixedly mounted and the lower connector assembly and lower housing move relative to the upper connector assembly.

As described in aforesaid U.S. Pat. No. 6,261,122 the upper and lower connector assemblies support and carry electrical contact plates carried in mounting bodies which are spring supported on the connector assembly such that as the lower housing and connector assembly are moved through the latching movement relative to the upper connector assembly the electrical contact plates are brought into seated socket connection under opposed spring influence which allows for continued housing movement to provide for a latch or an unlatch while electric connection is maintained.

While the use of multi-pin and socket connections are common in the art, video signals are often times transmitted by shielded wiring systems such as coax cable. To accommodate the use of coax, this invention provides a connector assembly particularly adapted for use with coax. Preferably the connector assembly would be mounted with the coax connection on one side and a multi-pin electrical connector on the other side of the upper and lower connector assemblies. This allows for the adaptation of guidance pins particularly chosen for the different types of connectors.

As illustrated in FIGS. 2, mounting bodies 34 and 35 are carried by, respectively, the upper 30 and lower 32 connector assemblies. Each mounting body is provided with openings 37 through which pins 38 project, the pins being fixably attached to the connector assemblies such as at 40. Springs 41 are interposed between the attachment points 40 and the mounting bodies 34, 35. In this manner the mounting bodies are free to float with respect to the connector assemblies 30, 32 under a spring bias on the pins 38.

Stops 42 affixed to the pins on the side of the mounting bodies opposite the springs limit movement of the mounting bodies away from the attachment points 40. The stops may be of a fixed position as shown at 42or may be adjustable as by threaded members as shown at 43.

For each opposed pair of pins, one carries a locating pin 45 and the opposite carries a locating socket 46. As illustrated in FIG. 2 the sockets can be attached to one of the connector assemblies and the pins attached to the other or, for example, a pin and a socket may be carried by each. As the connector assemblies move towards one another as the lower housing is raised to the upper housing, the pins will enter the sockets providing proper alignment for the mounting bodies. Adjustable spacers 50 may be carried by one of the mounting bodies in opposition to the other of the mounting bodies to limit the motion of the mounting bodies towards one another and maintains a desired minimum spacing. Preferably the stops are adjustably postitionaly connected as at 51 to the associated mounting body. The mounting bodies carry opposed coax push connector plugs 53 including a male plug connection and female plug connection 54 of known types and F type quick connect connectors are preferred. One carries a central projecting internal wire and the other has an internal socket for receipt of the wire providing a first connector. The connectors telescope with a second connection made at the outer diameter of the male member and at another shell inner diameter of the female member.

It will be appreciated that the adjustable stops 50 are positioned to maintain the mounting bodies properly spaced such that the connectors 53 and 54 are brought into proper seated contact without being so urged against one another in a manner to cause damage.

As a specific feature of this invention, the connectors 53 and 54 have their opposite ends formed as BNC connectors which allow for secure but easily disconnectable connections to be made. In this manner complicated rewiring, sodering, crimping, etc. is avoided when, for example, it becomes necessary to remove the camera's video connection.

It will therefore be seen from the above that this invention provides an improved remote surveillance security camera paired with a light fixture with the camera lens axis and the light fixture light beam fixed substantially parallel to one another, and the camera and light fixture's beam carried by a pan and tilt drive. The surveillance camera, light fixture, drive combination may be direct mounted to a pole or the like or may be connected through a fixture lowering system, the fixture lowering system having a coax cable connection for the video signal. It will apparent to those skilled in the art that variations may be made to the embodiment illustrated. For example, a plurality of light fixtures could be arranged in association with the camera having different beam characteristics and the camera could be adapted to respond to differing beam characteristics, as an example an inferred light may be used with an appropriate camera.

I claim as my invention:

1. A security surveillance system for remote monitoring comprising a video camera mounted to a pan and tilt drive in a manner allowing the drive to rotate and elevate or depress the camera view, a light fixture carried by the pan and tilt drive having a beam axis substantially parallel to a lens axis of the video camera, the camera and light fixture moved in unison by the pan and tilt drive.

2. A security system according to claim 1 wherein the light fixture and camera are independently actuatable.

3. A security system according claim 1 wherein the light fixture is a hot restrike HID lamp fixture.

4. A security system according to claim 1 wherein the pan and tilt drive is attached to a pole elevating the camera and light fixture above the ground.

5. A security system according to claim 4 wherein the pan and tilt drive is attached to the pole through a fixture lowering assembly.

6. A surveillance system according to claim 5 wherein the fixture lowering assembly includes upper and lower housings containing respectively upper and lower connector assemblies, the upper housing being connected fixedly to a mount and the lower assembly being moveable towards and away from the upper assembly and being attachable and detachable thereto.

7. A security system according to claim 6 wherein the connector assemblies include mating coax connectors for carrying the camera video signal.

8. A video surveillance system comprising a video camera showing an axis of view, a lamp fixture having a beam direction, a pan and tilt drive, bracketing attaching the video camera and the lamp fixture to the pan and tilt drive with the axis of view and the beam direction substantially parallel to one another, the pan and tilt drive effective to simultaneously move the camera and the light fixture.

9. A surveillance system according to claim 8 wherein the light fixture includes a hot restrike HID lamp which is remotely independently actuatable from the camera.

10. A pole mounted surveillance system comprising a pole having an elevated arm extending therefrom, the arm supporting a fixture lowering assembly including upper and lower housing portions containing respectively upper and lower connection assemblies, the lower housing carrying a pan and tilt drive, the pan and tilt drive operatably coupled to a light fixture and to a video camera for simultaneous controlled movement of both fixture and camera with respect to the pole.

11. A surveillance system according to claim 10 wherein the connector assemblies include opposed male and female coax connectors which are brought into and out of electrical connection during latching and unlatching movements of the upper and lower housings.
